(19) United States
(12) Patent Application Publication
(10) Pub. No.: US 2004/0021765 A1
(43) Pub. Date: Feb. 5, 2004

(54) Speech recognition system for managing telemeetings

(76) Inventors: Francis Kubala, Boston, MA (US); Daniel Kiecza, Cambridge, MA (US)

Correspondence Address: Leonard C. Suchyta, c/o Christian Anderson, Verizon Corporate Services Group Inc., 600 Hidden Ridge, HQE03H01, Irving, TX, 75038, US

(21) Appl. No.: 10/610,698

(22) Filed: Jul. 2, 2003

Related U.S. Application Data
(60) Provisional application No. 60/394,064, filed on Jul. 3, 2002.
(60) Provisional application No. 60/394,082, filed on Jul. 3, 2002.
(60) Provisional application No. 60/419,214, filed on Oct. 17, 2002.

(51) Int. Cl. H04N 7/14

(52) U.S. Cl. 348/14.08

(57) ABSTRACT

An automated meeting facilitator [109] manages and archives a telemeeting. The automated meeting facilitator includes a multimedia indexing section [220], a memory section [230], and a server [240]. The automated meeting facilitator may connect to meeting participants [102] through a network. The multimedia indexing section [220] generates rich transcriptions of the telemeeting and stores documents related to the telemeeting. Through the rich transcription, the automated meeting facilitator is able to provide a number of real-time search and assistance functions to the meeting participants.

### RELATED APPLICATIONS

This application claims priority under 35 U.S.C. §119 based on U.S. Provisional Application Nos. 60/394,064 and 60/394,082 filed Jul. 3, 2002 and Provisional Application No. 60/419,214 filed Oct. 17, 2002, the disclosures of which are incorporated herein by reference.

### BACKGROUND OF THE INVENTION

1. Field of the Invention

The present invention relates generally to speech recognition and, more particularly, to the use of speech recognition in managing telemeetings.

2. Description of Related Art

Telemeetings, such as video conferences and teleconferences, are an important part of the modern business environment. Information shared in such telemeetings, however, is often ephemeral and/or difficult to manage. A scribe may take the minutes of a meeting to summarize the meeting in a written document. Such a summary, however, may lack significant details that may be important or that may later be seen to be important.

It would be desirable to more effectively archive the contents of a telemeeting. As digital mass storage densities continue to increase, the storage capacity will arrive to archive the full contents of a meeting so that anything that might be useful later can be saved. Currently, the dominant issues are organization and retrieval of the archived data. This can be a difficult problem as speech has not traditionally been valued as an archival information source. As effective as the spoken word is for communicating, archiving spoken segments in a useful and easily retrievable manner has long been a difficult proposition. Although the act of recording audio is not difficult, automatically transcribing and indexing speech in an intelligent and useful manner can be difficult.

In addition to being able to more effectively archive the contents of a telemeeting, it would also be desirable to automatically manage aspects of the telemeeting. For example, traditionally, a designated assistant is assigned tasks, such as keeping the meeting agenda, copying and distributing copies of documents that will be discussed in the meeting, and contacting additional parties during the course of the meeting.

It would be desirable to more efficiently manage telemeetings such that information relating to the meeting can be effectively archived and retrieved and the meeting can be automatically administered.

### SUMMARY OF THE INVENTION

Systems and methods consistent with the present invention automatically manage and facilitate telemeetings.

One aspect of the invention is directed to a method for facilitating a telemeeting. The method comprises recording contributions of participants in a telemeeting, automatically transcribing the contributions of the participants, and making the telemeeting transcription available to the participants while the telemeeting is ongoing.

A second aspect of the invention is directed to an automated telemeeting facilitator that includes indexers, a memory system, and a server computer. The indexers receive multimedia streams generated by participants in a telemeeting and generate rich transcriptions corresponding to the multimedia streams. The memory system stores the rich transcriptions and the multimedia streams. The server computer answers requests from the participants relating to items previously discussed in the telemeeting based on the rich transcriptions.

Another aspect of the invention is directed to a method that includes storing documents related to a telemeeting and storing multimedia data of the telemeeting. The method further includes generating transcription information corresponding to the multimedia data, storing the transcription information, and providing the documents, the multimedia data, and the transcription information to users based on user requests.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram illustrating a telemeeting;

FIG. 2 is a diagram of a system consistent with the present invention;

FIG. 3 is an exemplary diagram of the audio indexer of FIG. 2 according to an implementation consistent with the principles of the invention;

FIG. 4 is an exemplary diagram of the recognition system of FIG. 3 according to an implementation consistent with the present invention;

FIG. 5 is a diagram illustrating the memory system shown in FIG. 2 in additional detail;

FIG. 6 is a diagram illustrating exemplary content of a database; and

FIGS. 7 and 8 are flow charts illustrating operation of a telemeeting facilitator consistent with aspects of the invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

A telemeeting facilitator, as described below, automatically assists users in holding telemeetings and provides a number of archival and information management features that enrich the value of the telemeeting. More particularly, the telemeeting facilitator provides pre-meeting organizational support, intra-meeting transcription and real-time information access, and post-meeting archival services.

### TELEMEETING FACILITATOR

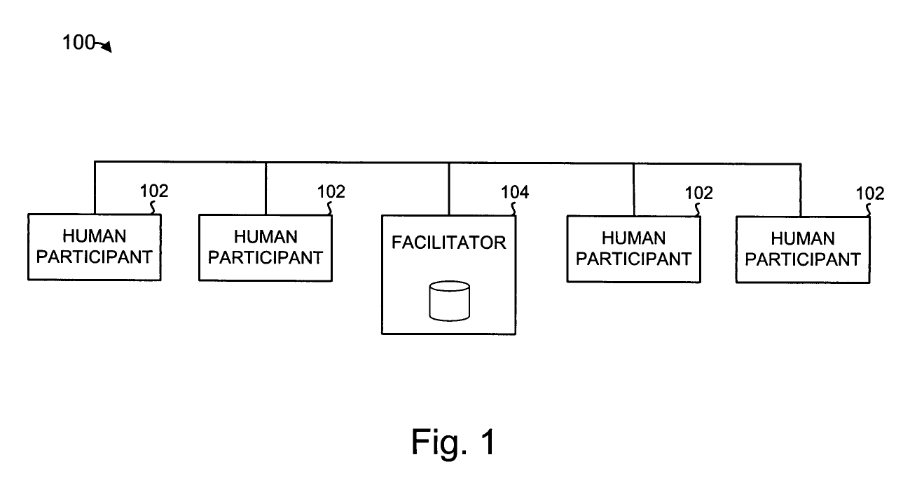

FIG. 1 is a diagram conceptually illustrating a telemeeting 100. As described herein, a telemeeting may refer to a video or audio teleconference. Telemeeting 100 may include a number of human participants 102 and a machine facilitator 104. Participants 102 may connect to the telemeeting in a number of different ways, such as by calling a call center (not shown) or facilitator 104 at a designated time. Facilitator 104 performs a number of different functions relating to the telemeeting.

In general, one set of functions performed by facilitator 104 relates to setting-up of the telemeeting. Facilitator 104 may store emails, voicemails, agenda information, or other documents that are submitted by participants 102 prior to the telemeeting. Facilitator 104 may then make these documents available to the participants during the meeting.

A second set of functions performed by facilitator 104 relates to on-line assistance and recording during the telemeeting. Facilitator 104 may, for example, place calls to prospective participants or otherwise initiate contact with a person. Facilitator 104 may also record and transcribe, in real-time, conversations between participants. The term “real-time,” as used herein, refers to a transcription that is produced soon enough after the audio is received to make the transcription useful during the course of the teleconference. For example, the rich transcription may be produced within a few seconds of the arrival of the input audio data.

Another set of functions performed by facilitator 104 relates to post-telemeeting functions. Facilitator 104 may store the minutes of a telemeeting, a rich transcription of the telemeeting, and any other documents that the participants 102 wish to associate with the telemeeting. Participants may view and search this information.

The implementation and operation of facilitator 104 will be discussed in more detail below.

### EXEMPLARY SYSTEM

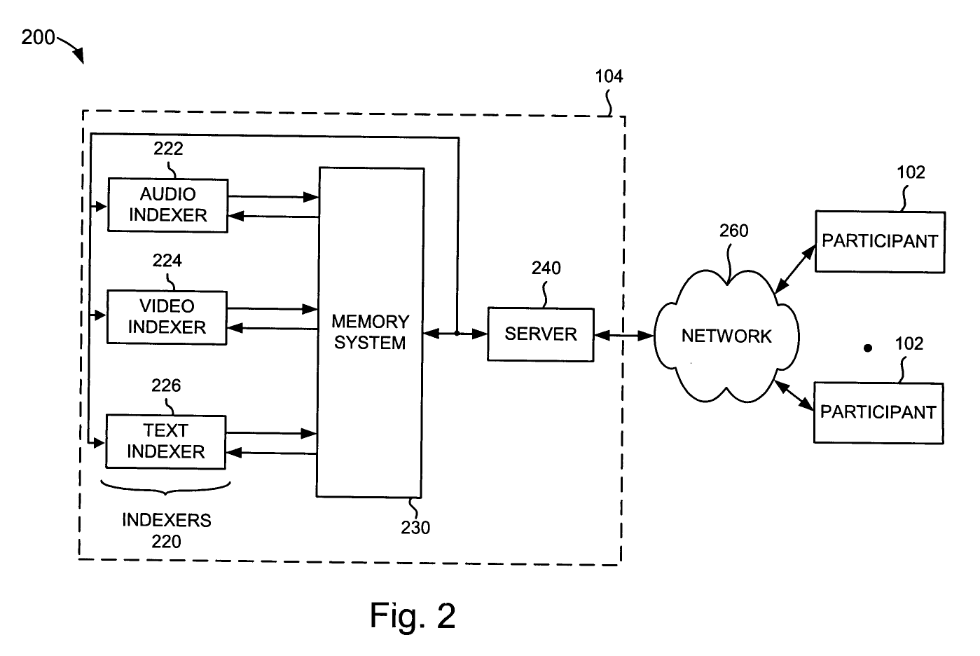

FIG. 2 is a diagram illustrating an exemplary system 200 including facilitator 104 consistent with an aspect of the invention. Facilitator 104 may include indexers 220, memory system 230, and server 240 connected to participants 102 via network 260. Network 260 may include any type of network, such as a local area network (LAN), a wide area network (WAN) (e.g., the Internet), a public telephone network (e.g., the Public Switched Telephone Network (PSTN)), a virtual private network (VPN), or a combination of networks. In one implementation, network 260 may include both a PSTN through which participants dial-in to facilitator 104 and a data network, such as the Internet, through which participants connect via a packet-based network connection (e.g., a participant may sit at a client computer that includes a microphone and camera and that transmits and receives voice and video over network 260). The various connections shown in FIG. 2 may be made via wired, wireless, and/or optical connections.

Indexers 220 may include one or more audio indexers 222, one or more video indexers 224, and one or more text indexers 226. Each of indexers 222, 224, and 226 may include mechanisms that receive data from participants 102. Data from participants 102 may include audio data (e.g., telephone conversations), video data, or textual documents, which are received by audio indexer 222, video indexer 224, and text indexer 226, respectively. The audio data, video data, and textual documents can be collectively referred to as multimedia data. Indexers 220 may process their input data and perform feature extraction, then output analyzed, marked-up, and enhanced language metadata. In one implementation consistent with the principles of the invention, indexers 220 include mechanisms, such as the ones described in John Makhoul et al., “Speech and Language Technologies for Audio Indexing and Retrieval,” Proceedings of the IEEE, Vol. 88, No. 8, August 2000, pp. 1338-1353, which is incorporated herein by reference.

Audio indexer 222 may generate metadata from its audio input sources. For example, indexer 222 may segment the input data by speaker, cluster audio segments from the same speaker, identify speakers by name or gender, and transcribe the spoken words. Indexer 222 may also segment the input data based on topic and locate the names of people, places, and organizations. Indexer 222 may further analyze the input data to identify when each word was spoken (possibly based on a time value). Indexer 222 may include any or all of this information in the metadata relating to the input audio data.

Video indexer 224 may generate metadata from its input video sources. For example, indexer 224 may segment the input data by speaker, cluster video segments from the same speaker, identify speakers by name or gender, identify participants using face recognition, and transcribe the spoken words. Indexer 224 may also segment the input data based on topic and locate the names of people, places, and organizations. Indexer 224 may further analyze the input data to identify when each word was spoken (possibly based on a time value). Indexer 224 may include any or all of this information in the metadata relating to the input video data.

Text indexer 226 may generate metadata from its input textual documents. For example, indexer 226 may segment the input data based on topic and locate the names of people, places, and organizations. Indexer 226 may further analyze the input data to identify when each word occurs (possibly based on a character offset within the text). Indexer 226 may include any or all of this information in the metadata relating to the input text data.

In one implementation, text indexer 226 is an optional component. Textual documents input by participants 102 may alternatively be stored straight into memory system 230.

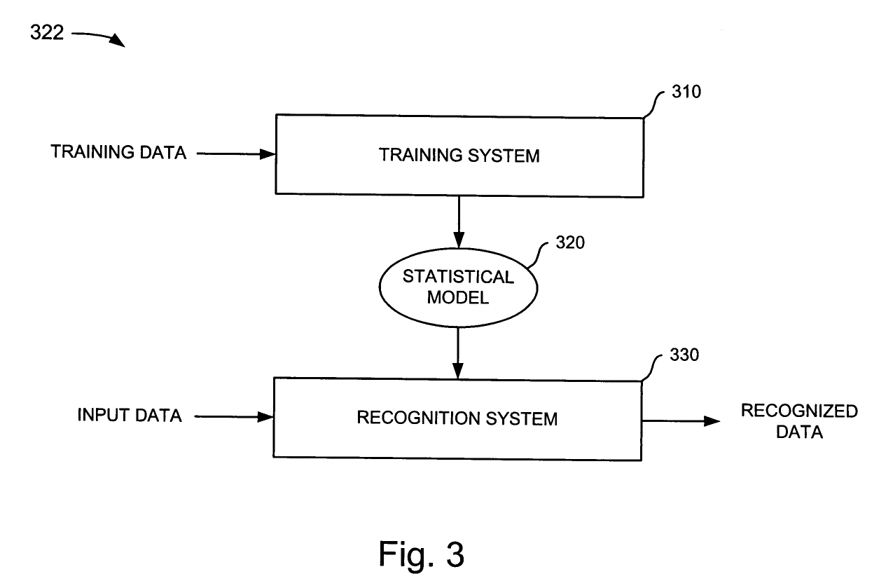

FIG. 3 is an exemplary diagram of audio indexer 222. Video indexer 224 and text indexer 226 may be similarly configured. Indexers 224 and 226 may include, however, additional and/or alternate components particular to the media type involved.

As shown in FIG. 3, indexer 222 may include training system 310, statistical model 320, and recognition system 330. Training system 310 may include logic that estimates parameters of statistical model 320 from a corpus of training data. The training data may initially include human-produced data. For example, the training data might include one hundred hours of audio data that has been meticulously and accurately transcribed by a human. Training system 310 may use the training data to generate parameters for statistical model 320 that recognition system 330 may later use to recognize future data that it receives (i.e., new audio that it has not heard before).

Statistical model 320 may include acoustic models and language models. The acoustic models may describe the time-varying evolution of feature vectors for each sound or phoneme. The acoustic models may employ continuous hidden Markov models (HMMs) to model each of the phonemes in the various phonetic contexts.

The language models may include n-gram language models, where the probability of each word is a function of the previous word (for a bi-gram language model) and the previous two words (for a tri-gram language model). Typically, the higher the order of the language model, the higher the recognition accuracy at the cost of slower recognition speeds.

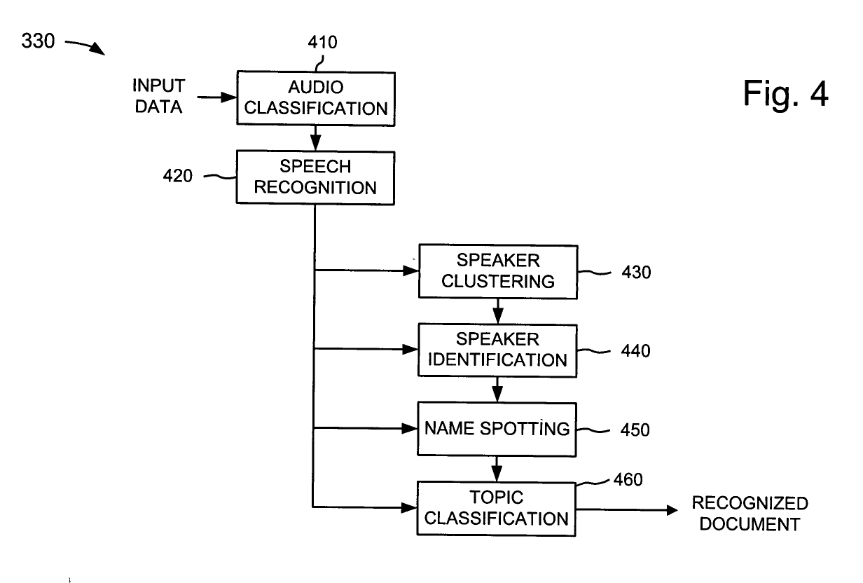

Recognition system 330 may use statistical model 320 to process input audio data. FIG. 4 is an exemplary diagram of recognition system 330 according to an implementation consistent with the principles of the invention. Recognition system 330 may include audio classification logic 410, speech recognition logic 420, speaker clustering logic 430, speaker identification logic 440, name spotting logic 450, and topic classification logic 460. Audio classification logic 410 may distinguish speech from silence, noise, and other audio signals in input audio data. For example, audio classification logic 410 may analyze each thirty second window of the input data to determine whether it contains speech. Audio classification logic 410 may also identify boundaries between speakers in the input stream. Audio classification logic 410 may group speech segments from the same speaker and send the segments to speech recognition logic 420.

Speech recognition logic 420 may perform continuous speech recognition to recognize the words spoken in the segments that it receives from audio classification logic 410. Speech recognition logic 420 may generate a transcription of the speech using statistical model 320. Speaker clustering logic 430 may identify all of the segments from the same speaker in a single document (i.e., a body of media that is contiguous in time (from beginning to end or from time A to time B)) and group them into speaker clusters. Speaker clustering logic 430 may then assign each of the speaker clusters a unique label. Speaker identification logic 440 may identify the speaker in each speaker cluster by name or gender.

Name spotting logic 450 may locate the names of people, places, and organizations in the transcription. Name spotting logic 450 may extract the names and store them in a database. Topic classification logic 460 may assign topics to the transcription. Each of the words in the transcription may contribute differently to each of the topics assigned to the transcription. Topic classification logic 460 may generate a rank-ordered list of all possible topics and corresponding scores for the transcription. Topic classification logic 460 may output the metadata in the form of documents to memory system 230, where a document corresponds to a body of media that is contiguous in time (from beginning to end or from time A to time B).

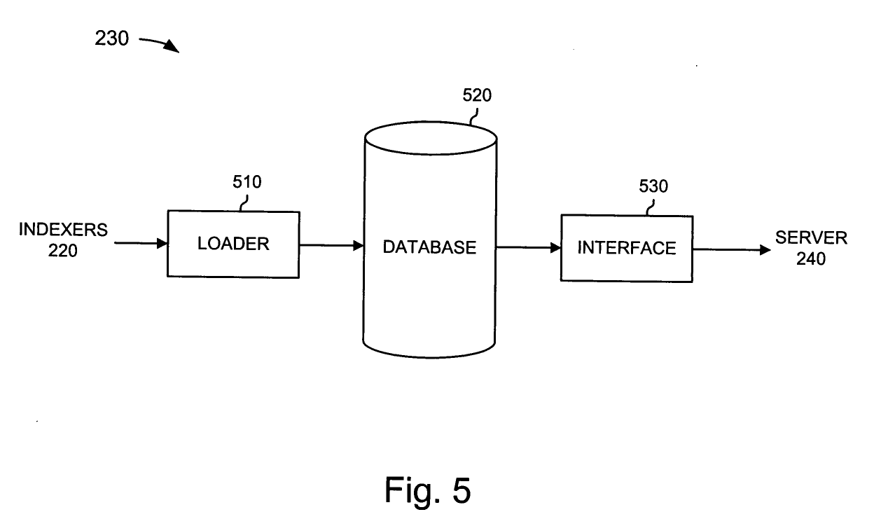

Returning to FIG. 2, memory system 230 may store documents from indexers 220. Memory system 230 may also store the original audio and video information corresponding to the documents. FIG. 5 is an exemplary diagram of memory system 230 according to an implementation consistent with the principles of the invention. Memory system 230 may include loader 510, one or more databases 520, and interface 530. Loader 510 may include logic that receives information from indexers 220 and stores them in database 520.

Database 520 may include a conventional database, such as a relational database, that stores documents from indexers 220. Database 520 may also store documents received directly from participants 102. Interface 530 may include logic that interacts with server 240 to store documents in database 530, query or search database 530, and retrieve documents from database 530.

Returning to FIG. 2, server 240 may include a computer or another device that is capable of interacting with memory system 230 and participants 102 via network 260. Server 240 may receive queries and telemeeting conversations from participants 102 and use the queries to perform meeting facilitation functions. More particularly, server 240 may include software components that direct the operation of indexers 220 and memory system 230, and that interacts with participants 102 via network 260.

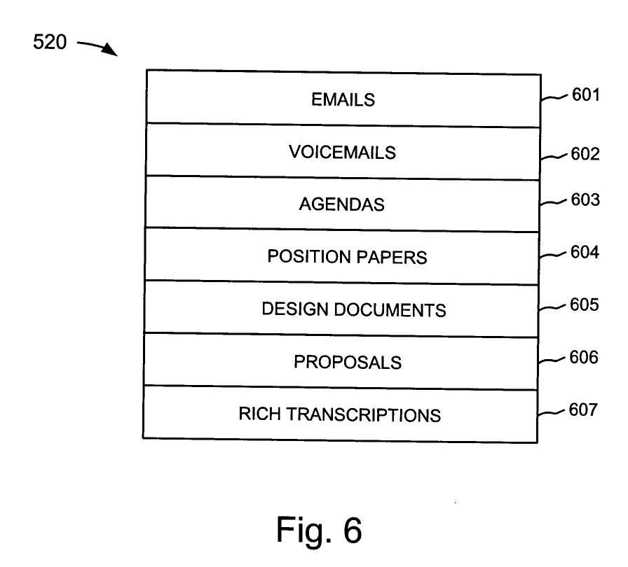

FIG. 6 is a diagram illustrating database 520 in additional detail. In particular, FIG. 6 illustrates exemplary objects relating to a particular telemeeting that may be stored in database 520. As shown, database 520 may store emails 601, such as emails that participants 102 may send to each other prior to or during a telemeeting. Similarly, voicemails 602 exchanged in setting up a telemeeting, as well as transcriptions of the voicemails, may be stored in database 520. Documents relating to the telemeeting, such as meeting agendas 603, position papers 604, design documents 605, and proposals 606 may also be stored in database 520. These documents may be uploaded by participants 102 prior to, during, or after a telemeeting. Further, database 520 stores the previously discussed rich transcriptions 607 that were produced by indexers 220. In this manner, database 520 may store a complete record of the telemeeting.

### OPERATION OF FACILITATOR

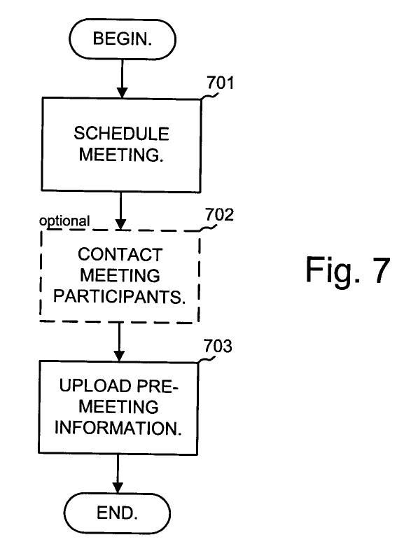

FIG. 7 is a flow chart illustrating operation of facilitator 104 in initially setting up a telemeeting.

A user begins by scheduling a meeting with facilitator 104 (act 701). The meeting could be a regularly occurring meeting or a one time event. The user may enter information relating to the meeting, such as the time, room number, expected participants, and telephone or IP address contact number. Based on the user's preferences, facilitator 104 may automatically contact the intended participants to alert or remind them of the telemeeting (act 702). For example, facilitator 104 may automatically send an email alert to the participants.

Participants 102 may upload pre-meeting information to database 520 of facilitator 104 (act 703). The pre-meeting information may include, for example, a meeting agenda 603, position papers 604, design documents 605, voicemails 602, and proposals 606. Other participants may then log onto facilitator 104 before, during, or after the meeting and review the pre-meeting information. In some implementations, facilitator 104 may allow a number of participants to edit one of documents 603-606. In this manner, facilitator 104 enables group collaboration features for these documents.

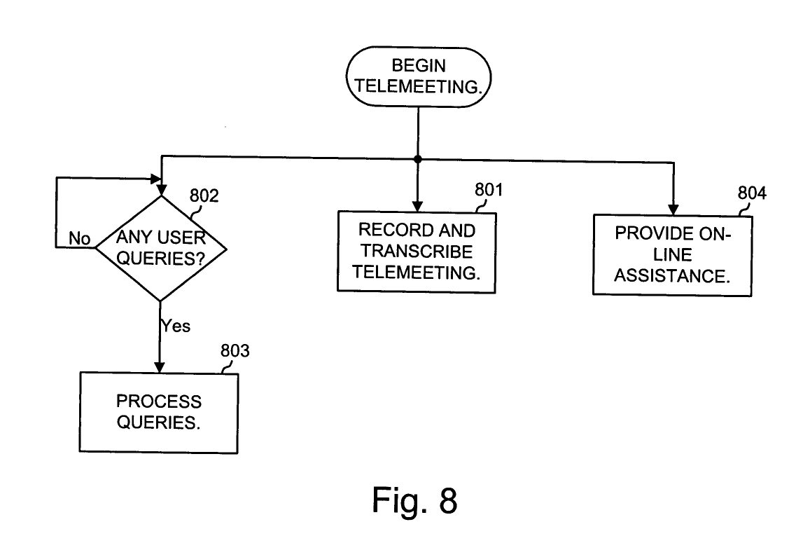

Once a telemeeting begins, facilitator 104 performs a number of intra-meeting functions. FIG. 8 is a flow chart illustrating operation of facilitator 104 during a telemeeting. As participants speak, facilitator 104 records and transcribes their words using indexers 220 (act 801). The transcription may be performed in real-time and may be a rich transcription that includes metadata that identifies the various speakers. Participants 102 may search and view the transcription during the telemeeting.

In addition to simply generating a transcription of the telemeeting, facilitator 104 may provide functionality relating to the real-time transcription of the telemeeting. In particular, facilitator 104 may answer user queries relating to the transcription (acts 802 and 803). The queries may include queries relating to: (1) what a particular participant said, (2) how far along in the agenda the meeting has progressed, (3) how much time was allotted for a particular item in the agenda, (4) when a particular participant arrived at the meeting, and (5) if a particular participant was at the meeting while a particular topic was being discussed. In answering these queries, facilitator 104 examines the elements stored in database 520. For example, because rich transcriptions 607 include speaker identification markings, facilitator 104 is able to identify what any particular participant has said. Similarly, facilitator 104 may use the topic identification information in rich transcriptions 607 to determine the presently discussed topic relative to the agenda 603.

Facilitator 104 may also provide on-line assistance to participants 102 during the course of a telemeeting (act 804). A participant may ask facilitator 104, either verbally or via a typed question, to contact another person. If the question was a verbal question, facilitator 104 may, via speech recognition system 330, transcribe the question. Facilitator 104 may then parse the question to determine its intended meaning. If, for example, the question was “call Bob Smith,” facilitator 104 may initiate a call to a number that was pre-stored as corresponding to Bob Smith. In this manner, Bob Smith may be joined in the telemeeting.

In addition to contacting a potential participant, facilitator 104 may assist participants in other ways during the meeting. Facilitator 104 may, for example, search structured resources or the world-wide-web in response to participant questions.

Facilitator 104 may continue to save the rich transcriptions and recorded conversations after the telemeeting is over. Users may then later review and search the rich transcriptions, as well as the original audio and video data corresponding to the rich transcriptions.

### CONCLUSION

As described herein, a meeting facilitator manages a telemeeting. The automated facilitator generates rich transcriptions of the telemeeting and stores documents related to the telemeeting. Through the rich transcription, the facilitator is able to provide a number of real-time search and assistance functions to the meeting participants.

The foregoing description of preferred embodiments of the invention provides illustration and description, but is not intended to be exhaustive or to limit the invention to the precise form disclosed. Modifications and variations are possible in light of the above teachings or may be acquired from practice of the invention. For example, while series of acts have been presented with respect to FIGS. 7 and 8, the order of the acts may be different in other implementations consistent with the present invention. Additionally, although a telemeeting was described as corresponding to a video or telephone conference, concepts consistent with the present invention could be more generally applied to the gathering of a number of people in a conference room.

Certain portions of the invention have been described as software that performs one or more functions. The software may more generally be implemented as any type of logic. This logic may include hardware, such as application specific integrated circuit or a field programmable gate array, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed:

1. A method for facilitating a telemeeting, the method comprising:
recording contributions of a plurality of participants in the telemeeting;
automatically transcribing the contributions of the participants to obtain a telemeeting transcription; and
making the telemeeting transcription available to the participants while the telemeeting is ongoing.

2. The method of claim 1, wherein making the telemeeting transcription available to the participants includes:
accepting search queries from the participants, and
searching the telemeeting transcription based on the search queries.

3. The method of claim 1, wherein making the telemeeting transcription available to the participants includes:
accepting search queries from the participants, and
returning answers to the search queries based on the telemeeting transcription.

4. The method of claim 1, further comprising:
providing on-line assistance to the participants during the course of the telemeeting.

5. The method of claim 4, wherein the on-line assistance includes automatically contacting a person identified by one of the participants of the telemeeting.

6. The method of claim 1, wherein the telemeeting transcription is a rich transcription that includes at least one of: speaker identification information and topic classification information.

7. The method of claim 1, further comprising:
storing documents identified by the participants as being related to the telemeeting.

8. The method of claim 7, wherein the documents include at least one of: meeting agendas, position papers, design documents, and proposals.

9. The method of claim 1, further comprising:
storing at least one of emails and voicemails exchanged prior to the telemeeting and relating to the telemeeting.

10. An automated telemeeting facilitator comprising:
indexers configured to receive multimedia streams generated by participants in a telemeeting and generate rich transcriptions corresponding to the multimedia streams;
a memory system configured to store the rich transcriptions and the multimedia streams; and
a server computer system coupled to the memory system and configured to answer requests from the participants relating to items previously discussed in the telemeeting based on the rich transcriptions.

11. The automated telemeeting facilitator of claim 10, wherein the memory system is configured to additionally store at least one of emails and voicemails exchanged prior to the telemeeting and relating to the telemeeting.

12. The automated telemeeting facilitator of claim 11, wherein the memory system is configured to additionally store documents identified by the participants as being related to the telemeeting.

13. The automated telemeeting facilitator of claim 12, wherein the documents include at least one of: meeting agendas, position papers, design documents, and proposals.

14. The automated telemeeting facilitator of claim 12, wherein the server computer provides searchable access to the rich transcriptions and the documents after conclusion of the telemeeting.

15. The automated telemeeting facilitator of claim 10, wherein the indexers include an audio indexer that comprises:
statistical acoustic and language models, and
a recognition system that generates the rich transcriptions based on the statistical acoustic and language models.

16. The automated telemeeting facilitator of claim 15, wherein the recognition system comprises at least one of audio classification logic, speech recognition logic, speaker clustering logic, speaker identification logic, name spotting logic, and topic classification logic.

17. The automated telemeeting facilitator of claim 10, wherein the server is further configured to provide on-line assistance to the participants during the telemeeting.

18. The automated telemeeting facilitator of claim 17, wherein the on-line assistance includes automatically contacting a person identified by one of the participants of the telemeeting.

19. A system comprising:
means for connecting a plurality of participants in a telemeeting;
means for recording conversations of the participants, as recorded conversations, during the telemeeting;
means for transcribing the recorded conversations of the participants to form transcribed conversations;
means for receiving, during the telemeeting, queries from the participants relating to the transcribed conversations of the participants; and
means for responding to the queries based on the transcribed conversations.

20. The system of claim 19, further comprising:
means for storing non-conversational data related to the telemeeting, the non-conversational data including at least one of emails, meeting agendas, position papers, and design documents.

21. The system of claim 20, further comprising:
means for making the non-conversational data, the transcribed conversations, and the recorded conversations available to users for review after conclusion of the telemeeting.

22. A method comprising:
storing documents related to a telemeeting;
storing multimedia data of the telemeeting;
generating transcription information corresponding to the multimedia data;
storing the transcription information; and
providing the documents, the multimedia data, and the transcription information to users based on user requests.

23. The method of claim 22, wherein the transcription information is a rich transcription that includes at least one of: speaker identification information and topic classification information.

24. The method of claim 22, wherein providing the documents, the multimedia data, and the transcription information to users based on user requests is performed after conclusion of the telemeeting.

25. The method of claim 22, further comprising:
accepting search queries from participants of the telemeeting while the telemeeting is in progress; and
searching the transcription information based on the search queries.

26. The method of claim 22, further comprising:
accepting search queries from participants of the telemeeting while the telemeeting is in progress; and
returning answers to the search queries based on the transcription information.

27. The method of claim 22, further comprising:
providing on-line assistance to participants of the telemeeting during the telemeeting.

28. The method of claim 27, wherein the on-line assistance includes automatically contacting a person identified by one of the participants of the telemeeting.

29. The method of claim 22, wherein the documents include at least one of: meeting agendas, position papers, design documents, and proposals.

30. A computer-readable medium containing programming instructions for execution by a processor, the computer readable medium comprising:
instructions for recording conversations of a plurality of participants in a meeting;
instructions for transcribing the conversations of the plurality of participants to obtain a meeting transcription, the meeting transcription including metadata that identifies when a particular one of the participants is speaking; and
instructions for responding to queries relating to the meeting transcription during the course of the meeting.

31. The computer-readable medium of claim 30, wherein the instructions for responding to queries include:
instructions for accepting search queries from the participants, and
instructions for searching the meeting transcription based on the search queries.

32. The computer-readable medium of claim 30, wherein the instructions for responding to queries include:
instructions for accepting search queries from the participants, and
instructions for returning answers to the search queries based on the meeting transcription.

33. The computer-readable medium of claim 30, further comprising:
instructions for providing on-line assistance to the participants during the meeting.

34. The computer-readable medium of claim 33, wherein the on-line assistance includes automatically contacting a person identified by one of the participants of the meeting.

35. The computer-readable medium of claim 30, further comprising:
instructions for storing documents identified by the participants as being related to the meeting.

36. The computer-readable medium of claim 35, wherein the documents include at least one of: meeting agendas, position papers, design documents, and proposals.
